(19) United States
(12) Patent Application Publication
(10) Pub. No.: US 2025/0085233 A1
(43) Pub. Date: Mar. 13, 2025

(54) Method and apparatus for inspecting containers provided with fittings

(71) Applicant: KRONES AG, Neutraubling (DE)

(72) Inventors: Andreas Kraus, Lappersdorf (DE); Alexander Hewicker, Wörth an der Donau (DE); Anton Niedermeier, Offenstetten (DE); Stefan Piana, Koefering (DE)

(21) Appl. No.: 18/882,615

(22) Filed: Sep. 11, 2024

(30) Foreign Application Priority Data
Sep. 11, 2023 (DE) 10 2023 124 451.5

(51) Int. Cl. G01N 21/90; G01N 21/88; G06T 7/00; G06T 7/70

(52) U.S. Cl. CPC G01N 21/9045; G01N 21/8851; G06T 7/001; G06T 7/70; G01N 2021/8887

(57) ABSTRACT

Method for inspecting containers, wherein a fitting is applied to at least one surface region of an outer wall of a container, wherein this fitting has at least one carrier-free fitting element and preferably a plurality of fitting elements which are at least partially not connected to one another. The surface region fitted with this at least one fitting element or with these fitting elements is inspected by an inspection device and at least one characteristic value is output which is characteristic of at least one property that is characteristic of the first fitting element.

### BACKGROUND OF THE INVENTION

The present invention relates to a method and an apparatus for inspecting fitted containers, in particular liquids containers and in particular beverage containers.

Numerous methods and apparatuses of this kind are known from the prior art.

In the context of the present invention, fitting containers with fittings means in particular that the containers are provided with labels and/or prints. These labels and/or prints are applied in particular to a circumferential wall of the containers.

EP 2 290 355 A2 discloses an apparatus and a method for inspecting labeled vessels. A lighting device is provided which has at least two separately controllable light screens. A label is known from EP 3 612 452. EP 0 820 933 B1 describes a labeling machine.

Today, quality control of the labeling process, decoration process (hereinafter also referred to as the fitting process) or even a printing process is mostly carried out by camera-based inspection units. After the labeling process, these units check various aspects such as whether the label is positioned correctly or whether the label design is the correct one.

To determine the correct position (X/Y) and orientation (°) of a classic label, it is sufficient to check the position and orientation of a prominent (partial) location of the label or the fitting element. Since all decorative elements are firmly connected to one another via the label base material, such as paper or plastics material, the correct position of the entire label can be determined from at least one prominent spot.

The correct label design as a whole can be evaluated based on characteristic, meaningful locations. Thus, it is sufficient to identify a meaningful 1D or 2D code and to read a unique alphanumeric label ID number to identify the entire label as such.

If an error is detected, the entire system responds for example by ejecting the incorrectly labeled bottles and/or by counteracting the error if possible.

In the applicant's internal prior art, fitting processes have become known in which an entire label is not applied, but rather individual fitting elements are applied which, however, are advantageously not connected to one another.

A further new type of fitting or decoration method uses a new type of decor. This no longer has the base carrier material described in the “prior art,” i.e., the decoration in this case consists only of paint and adhesive and is therefore particularly susceptible to tearing, folding, small parts becoming detached, etc. during the entire treatment process.

Today, the inspection of a classic labeling does not include checking whether all individual elements of the individual decoration to be transferred are present and also completely present.

Nor is it checked whether the individual elements of the individual decorations have been transferred to the container completely and without damage, undistorted (and/or error-free, such as without cracks or the like).

Furthermore, it is also not checked whether all individual elements of the individual decoration to be transferred are correctly positioned in relation to one another, in particular in the running direction of the objects to be decorated, with regard to horizontal and vertical position and angular alignment, and/or are correctly positioned in relation to one another.

In addition, it is not checked whether all the individual elements of the individual decor to be transferred are correct (in particular, whether they are correct in terms of their content) and whether they represent the correct information content. This applies in particular to the so-called legal text, such as the alcohol content indication. If it were supposed to be 12% and the 1 was not transferred, the container would show 2% instead.

Furthermore, it is not checked whether the individual elements, and preferably all the individual elements, are dimensionally stable. For example, as the applicant has discovered in experiments, stretching of the compressions can occur when the fittings are applied.

In addition, the inspection systems known from the prior art as well as the corresponding labeling apparatuses or fitting apparatuses are not able to react appropriately to incorrect positioning of the individual elements in relation to one another.

### SUMMARY OF THE INVENTION

The present invention is therefore based on the object of improving the inspection of containers, in particular for containers which have a plurality of fitting elements.

This object is achieved according to the invention by the subjects of the independent claims. Advantageous embodiments and developments are the subject matter of the dependent claims.

In a method according to the invention for inspecting containers, a fitting is attached to at least one surface region of an outer wall of a container, wherein this fitting comprises at least one carrier-free fitting element and/or preferably a plurality of fitting elements which are at least partially not connected to one another. In the simplest case, however, it would also be possible to attach only one (in particular carrier-free) fitting element. The term “carrier-free” means in particular that the fitting element itself is attached to the container and in particular that the fitting element is not arranged on a carrier.

Preferably, none of the fitting elements is connected to a further fitting element. Preferably, the fitting does not have a carrier connecting the individual fitting elements. Preferably, therefore, the fitting elements are attached separately and/or individually to the surface region.

According to the invention, this at least one fitting element, or surface region fitted with these fitting elements, is inspected by an inspection device and at least one characteristic value is output which is characteristic of at least one property characteristic of the fitting element (or of these fitting elements).

This means that the property in question is preferably specifically characteristic of the fitting element in question and that the characteristic value is in turn characteristic of the property in question.

In the context of the present application, the term “fitting” is used, but in some cases the term “decorating” is also used. These two terms are considered synonymous.

In a further preferred method, the characteristic value can also be characteristic of an error condition of a fitting element or of the fitting, for example distortions, cracks, and the like.

In a preferred method, the property is a property that is individually characteristic of the first fitting element.

This means that this property characterizes only the first fitting element and not also further fitting elements, so that the first fitting element is examined individually. Preferably, several fitting elements are examined individually and preferably several such characteristic values are output.

In a preferred method, the property is a property that is individually characteristic of the first fitting element.

This means that this property characterizes only the first fitting element and not also further fitting elements, so that the first fitting element is examined individually. Preferably, multiple fitting elements are examined individually and preferably several such characteristic values are output.

In a preferred method, the characteristic value is characteristic of a position of a first fitting element with respect to the surface region and/or a position of a first fitting element with respect to a second fitting element.

The invention can therefore be applied when several fitting features are applied to the container, but it is also possible to apply it when only one (in particular carrier-free) fitting feature is applied.

The invention is therefore also applicable if there are not several fitting elements, but rather only one fitting element. If the fitting element is damaged, it (or the container in question) can be removed and, if necessary, a regulation or control intervention in the fitting process can be carried out, preventing future damage.

In a further preferred method, the characteristic value is characteristic of the agreement between an actual condition of the fitting element and a target condition of the fitting element, preferably the condition/deviation of the contour of the fitting element. If the contour deviation is in the range of a predefined threshold (preferably −0.2 mm, but also between −0.2 mm/−0.5 mm), the characteristic value is output.

In the context of the present patent application, a fitting is understood to mean in particular a decoration, but also markings which have an information content, such as names, numbers, letters, or codes. Preferably, the fitting and/or fitting elements are visually perceptible elements which are attached to the surface of the container. However, further fittings such as a container closure are preferably not within the scope of the present invention.

In a preferred method, the property is a property that is individually characteristic of the first fitting element.

This means that this property characterizes only the first fitting element and not also further fitting elements, so that the first fitting element is examined individually. Preferably, several fitting elements are examined individually and preferably several such characteristic values are output.

While the prior art does not provide any possibility of detecting the various system tolerances (bottle tolerances, feed tolerances, label element tolerances . . . ) in advance and of regulating them (during and/or between production operations), the invention proposes a possibility for such a regulation.

In addition, an option is also provided of readjusting the individual elements or fitting elements to a target distance after they have been placed if there is a trend of deviation from the target distance.

The inspection device preferably records several data and particularly preferably all relevant data necessary for control (of the fitting device). These data are preferably selected from a group of data which includes a position and/or location of the fitting elements (of an individual decoration or fitting in relation to one another), a rotational position of the fitting elements, and/or an actual shape of the fitting elements.

The inspection device also preferably detects all elements/individual elements that are important for the effect and message of the decoration, in particular texts, brand messages, legal notices, ingredients and proportions, etc. for completeness and accuracy.

The reason for this is the sensitivity of this decoration process described above, in particular the sensitivity of the decoration to be applied, as it lacks the usual carrier material for labels (paper labels=>paper; plastic labels=>plastic film).

If deviations are detected by the detecting system and a characteristic value is generated, the signal is passed on to, for example, a container ejection system in order to separate intolerable deviations from the good product stream and not process them further.

Alternatively (in particular deviations with a trend, individual deviations, or similar), the system (in particular a control device of the fitting device and/or the entire system) preferably readjusts these deviations (preferably in the running direction). This can be done, for example, via a servo control or similar.

Preferably, the inspection device records several and preferably all relevant data necessary for control, such as a position and/or orientation of the fitting elements in relation to one another.

This detection can preferably be carried out directly in the labeling apparatus or the fitting device. Here, the orientation of the containers with respect to their vertical axis is still substantially unchanged.

In a preferred method, the fitting is attached to containers that are already filled and sealed. However, it would be conceivable, in particular in the case of plastics material containers, to also attach the fitting to empty containers.

Preferably, printing is done on empty containers so that in the event of a misprint only the container, and not the product, has to be destroyed. Technically, however, both are possible.

It is also possible to carry out the detection only after the containers have been handed over, for example on a subsequent transport device. Since the container alignment is usually no longer guaranteed there, in this case an all-around detection with corresponding evaluation preferably takes place.

In addition, due to the longer transport route, the time constants for the regulation are significantly higher.

The regulation may use as an input variable only a distance value between two fitting elements of the decoration, but it is also possible to use a combination of different values (for example, several distance values, information on a rotational position of one or more fitting elements, and the like).

The regulation can act on several containers simultaneously, e.g., by varying the transport speed during application, but also on individual containers, for example by varying the rotational speed during application, or by a combination thereof.

In addition, it would also be conceivable to achieve a change by varying the transfer speeds of decoration on the containers to be decorated. Alternatively or additionally, an adjustment of certain positioning systems of the application would also be conceivable.

Preferably, the detection and control and/or regulation (of the fitting device) are carried out together on a computer unit. However, it would also be conceivable for these processes to be carried out in separate systems, e.g., in an inspection system for detection and in a machine control system for regulation, which can communicate via a suitable interface.

In the novel fitting or labeling process that is the subject matter of this application, the components of the label are applied to a carrier layer. The components of the label are enriched with an adhesive layer. The adhesive layer is preferably applied to the side facing away from the components of the carrier layer. Alternatively, the adhesive layer is applied to the side facing the components of the carrier layer.

When applying the components to the container, during the labeling process, or during the decoration or furnishing process, the components are removed from the carrier tape and applied to the containers without any carrier material. The adhesive layer forms a firm bond with the container and permanently fixes the label elements.

The carrier layer with the label is preferably inserted into the labeling machine as a roll with many “labels.” The carrier material is preferably retained at the labeling machine, collected, and disposed of.

In a preferred embodiment, the fitting and/or the fitting elements are visually and/or haptically perceptible.

Particularly preferably, the fitting elements are made of a plastics material. Preferably the container is also a plastics material container. However, the use of a glass container would also be conceivable. The container can also be a metallic container such as a can or a container made of fibers.

In a further preferred method, the fitting elements are attached to the containers starting from a carrier element, preferably a carrier tape. This means that the fitting elements are preferably initially located on a carrier tape and this carrier tape is preferably brought to the containers to be fitted, and in this way the fitting elements are transferred from the carrier tape to the container.

The carrier tape is preferably guided over an edge for the purpose of applying the fitting elements. Alternatively, the carrier tape is guided over rotating bodies and transfer elements located thereon (e.g., a transfer drum) for the purpose of applying the fitting elements.

Preferably, the fitting elements are selected from a group of fitting elements which contain QR codes, bar codes, numbers, letters, pictorial elements, and the like. The fitting elements can also be colored.

In a further preferred method, it is detected whether all fitting elements which are supposed to be present according to a specification are actually present. This is preferably done by comparing a target configuration of the fitting elements with an actual configuration. In this way, it can be checked whether a complete transfer of all fitting elements and also a complete transfer of each individual fitting element or even a complete transfer of only one fitting element onto the container has taken place. If it is found that individual fitting elements are missing, the container in question can be ejected and/or the fitting process can be checked.

If the individual fitting element is incomplete, damaged, torn, or similar, the container in question must be ejected. At the same time, the corresponding characteristic value could be used for a corresponding regulation or control of the decoration process, for example by adjusting or controlling a contact pressure, a relative transfer speed (the speed curve between the decoration element and the container during the contacting process), or other adjustment options.

In a further preferred method, it is checked whether the individual fitting elements are arranged at a target position (on the container and/or with respect to one another) and/or whether the individual fitting elements are arranged in a target rotational position on the container (and/or with respect to one another).

In a further preferred method, it is checked whether a fitting element actually applied to the container corresponds to a fitting element that is to be applied to the container. For example, a fitting element, e.g., in the form of a bar code, can indicate the liquid in the container. In this way, it can thus be determined whether the fitting element correctly indicates the liquid in the container.

In a further preferred method, an actual shape of a fitting element is compared with a target shape. For example, a compression or stretching of the fitting element actually attached to the container or the completeness of the contour of the fitting element can be checked or ascertained. In other words, it can be checked, for example, whether the actual shape of a label or the composition of the fitting elements or even of an individual fitting element corresponds to a target composition or a target shape.

When checking the contour, it is particularly preferable to detect deviations in the range of −0.2 mm to −0.5 mm compared to the target contour. This allows the system to detect very subtle deviations, but also massive deviations.

In a further preferred method, fitting elements are attached and in particular glued to the surface of the container.

The surface of the container is preferably an outer circumference. In particular, the container surface is a circumferential surface and in particular a cylindrical or frustoconical surface.

In a further preferred method, the surface region of the container to which the fitting elements are attached is a smooth or slightly curved surface region. However, it is also conceivable that the attachment is made to surfaces with a certain roughness (e.g., orange peel), since the adhesive layer arranged on the fitting elements can compensate for certain roughnesses.

Due to the absence of the carrier material, the decoration/fitting elements to be transferred can adapt more easily to curved surfaces. This makes them less susceptible to wrinkling or similar. Preferably, the transitions from smooth surfaces to these curves are gentle/flowing; edges should be avoided.

Due to the lack of a carrier material, this type of fitting can be a preferred alternative for so-called “no label look” labels (NLL-E). The NLL-Es are characterized by a flat transparent base material and partially printed regions. It is known in the art that NLL-Es easily cause air inclusions when applied to uneven surfaces. These air inclusions with their two additional optical boundary transitions from medium to air and vice versa are very clearly perceptible to the eye. Therefore, when applying an NLL-E, care is taken to ensure that it does not lie over the so-called press seam of the container, for example. The situation is different with this type of fitting. In particular, air inclusions cannot form between the fitting elements due to the design.

In a further preferred method, at least one fitting element has a predetermined minimum distance from at least one further fitting element and preferably from each further fitting element.

Particularly preferably, this minimum distance is greater than 0.5 mm, preferably greater than 1 mm, and particularly preferably greater than 1.5 mm. In a further preferred method, this minimum distance is less than 30 mm, preferably less than 25 mm, preferably less than 20 millimeters, and preferably less than 15 mm.

Preferably, limit values are defined within which a determined actual minimum distance should lie in relation to a target minimum distance between two fitting elements. If inspection determines that an actual minimum distance is outside these limits, countermeasures can be initiated.

In a further preferred method, the inspection is carried out by an image recording device, which preferably records at least one spatially resolved image of the surface provided with fitting elements.

Preferably, the images are recorded immediately after the containers have been fitted. Immediate is understood to mean that the image is recorded within a period of time after the fitting that is less than 10 s, preferably less than 8 s, preferably less than 6 s, preferably less than 5 s.

Particularly preferably, the surface is illuminated and in particular also illuminated during the creation of the image by the image recording device. In a further preferred method, the surface is illuminated using white light. Particularly preferably, the surface is illuminated by directed and/or diffuse radiation and in particular by directed and/or diffuse light.

Particularly preferably, images are recorded using a reflected light method. Particularly preferably, the lighting device is a flash lamp which illuminates the surface region of the container (provided with the fitting elements) at least for the period of the image recording.

In a further preferred method, the surface is recorded by several image recording devices.

Particularly preferably, a recorded image of the surface provided with the fitting elements is compared with at least one reference image. In this way, it is preferably determined whether all fitting elements are present and/or whether the fitting elements are in the correct position, the correct rotational position, and/or the correct distance from further fitting elements.

In a further preferred method, a geometric shape of at least one fitting element and preferably of several fitting elements is detected.

In a further preferred method, the characteristic value is selected from a group of characteristic values which comprises a characteristic value which is characteristic of a position of the fitting element relative to the surface region in a longitudinal direction of the container, of a position of the fitting element relative to the surface region in a circumferential direction of the container, of a position of a fitting element relative to a further fitting element in the longitudinal direction of the container, of a position of the fitting element relative to a further fitting element in a circumferential direction of the container, of a rotational position of the fitting element relative to the surface region, of a rotational position of the fitting element relative to a further fitting element, of a distortion of the fitting element, of a deformation of the fitting element, of a compression of the fitting element, of an expansion of the fitting element, of a presence of the fitting element, of an information content of the fitting element, of the agreement of an actual condition of the fitting element with a target condition of the fitting element, or combinations thereof.

Particularly preferably, several such characteristic values are detected. For example, a characteristic value can be detected which is characteristic of a position of a first fitting element relative to a second fitting element, a further characteristic value which is characteristic of a position of the first fitting element relative to a third fitting element, and one or more characteristic values which are characteristic of rotational positions of several fitting elements.

Preferably, the characteristic value is compared with a reference value and/or target value and preferably a signal characteristic of this comparison is output. For example, in response to this comparison, a control command can be output to the fitting device, or a command to eject the container in question can be output.

In a further preferred method, at least one image of the surface region fitted with the fitting elements is recorded and this image is compared with at least one reference image.

The position and rotation (location) of the individual fitting elements is preferably determined and compared in the reference and in the recording of the fitted surface. The comparison is preferably made between the absolute position relative to the surface and the position of the fitting elements relative to each other.

In a further preferred method, the attachment of the fitting and/or of the fitting elements to the container and/or the inspection of the container takes place during a movement of the container. Preferably, both the attachment of the fitting and/or of the fitting elements to the container and also the inspection of the container take place during a movement of the container.

Particularly preferably, the container is moved along a straight or curved (in particular circularly curved) transport path during the fitting and/or inspection.

In a further preferred method, the container is rotated with respect to its longitudinal axis during the fitting and/or inspection.

In a further preferred method, the fitting elements are applied to the container in the form of self-adhesive elements.

Particularly preferably, the fitting elements are applied substantially at the same time. This means that the fitting elements are applied within 10 s, preferably within 5 s, preferably within 3 s, and preferably within 1 s.

Particularly preferably, at least some of the fitting elements are attached to the container with a slight time offset. This time offset is preferably greater than 1 ms, preferably greater than 2 ms, preferably greater than 5 ms.

In a further preferred method, the fitting of the container with the fitting element(s) is controlled taking into account the characteristic value. For example, a regulating circuit can preferably be provided which carries out regulation, in particular of the fitting device, taking the characteristic value into account.

For example, the transport speed of the containers can be changed, the containers can be rotated, or the rotational speed of the containers can be changed.

In addition, a device that supplies the fitting elements to the containers can also have its working speed changed, for example.

The present invention further relates to a method for inspecting containers, wherein a container is provided and wherein a fitting is attached to at least one surface region of an outer wall of this container, wherein this fitting has at least one carrier-free fitting element and/or a plurality of fitting elements which are (at least partially) not connected to one another. Preferably, none of the fitting elements is connected to another fitting element.

According to the invention, this surface region fitted with these fitting elements is inspected by an inspection device and at least one characteristic value is output which is characteristic of the property that is characteristic of the (in particular at least one) fitting element.

Preferably, the characteristic value is characteristic of a position of a first fitting element with respect to the surface region and/or a position of a first fitting element with respect to a second fitting element.

It is therefore also proposed here that, in particular, the orientation and/or positioning of the fitting elements be checked.

The present invention further relates to an apparatus for inspecting containers and in particular containers that can be filled with liquid and in particular beverage containers, which device has at least one fitting device that is suitable and intended for attaching a fitting to at least one surface region of an outer wall of a container, wherein this fitting has at least one carrier-free fitting element and/or a plurality of fitting elements that are (at least partially) not connected to one another.

According to the invention, the apparatus has an inspection device which is suitable and intended to inspect this surface region fitted with these fitting elements and to output at least one characteristic value which is characteristic of at least one property that is characteristic of the fitting element.

Preferably, the characteristic value is characteristic of a position of a first fitting element with respect to the surface region and/or a position of the first fitting element with respect to a second fitting element.

The inspection system is preferably able to inspect the corresponding parts of the container. For this purpose, the inspection system can consist of one or more imaging sensors, such as 2D cameras, 2D/3D cameras, line cameras or the like.

The imaging sensor(s) or their optics can preferably block out certain polarization directions, in particular by suitable filters.

Furthermore, it is also possible for the sensor (or the image recording device) itself to be able to distinguish the polarization components (Sony—polarization sensor).

The illumination can be a continuous light, a switchable light, or preferably a flashed illumination with a flash duration of less than 1 ms, preferably less than 0.5 ms, particularly preferably less than 100 μs.

The illumination is preferably monochromatic in different wavelengths, such as red, green and blue, but also from UV, IR, or a combination of these wavelength ranges.

The lighting can preferably combine different sets of wavelengths depending on the type of production. The illumination can preferably be a continuous (partial) spectrum of visible light, so-called white light.

The lighting can also emit different wavelengths in parts, e.g., arranged in stripes or other patterns, e.g., as a two-color pattern, or as a rainbow pattern, or the like.

The lighting can also be diffuse, directed, and/or polarized.

The illumination device can be a reflected light, a transmitted light, a dark field or a combination of these types of illumination.

The imaging sensors can preferably adapt the focal plane, in particular by automatic, regulated or controlled adjustment at the lens, for different container diameters and thus the different distances to the sensor. This adjustment can preferably be made once when changing types.

The detection can take place in the labeling machine or the fitting device. For this purpose, at least one sensor can preferably be attached along the transport path (of the containers) and the corresponding label locations on the labeled container are preferably brought by the fitting device preferably approximately into a suitable position for detection by the sensor (or the image recording device) and the lighting.

Sensors are preferably installed along the transport route. These sensors can be assigned in portions, after each unit or at the end, but preferably by unit.

One or more sensors can also be arranged in a group in order to be able to map a larger circumferential area or the entire circumference of the container in combination with the container rotation along the transport path (in particular continuously, not a pulsed machine).

Preferably, a region sensor can image up to 120°, preferably up to 90°, particularly preferably 20-60° in sufficient quality.

The detection can be installed downstream of the labeling device or fitting device (in particular on the (transport) belt) (360° ETK on the belt). For this purpose, at least one sensor and one lighting unit are preferably arranged in such a way that they can detect part of the applied label.

Preferably, at least three, particularly preferably four or six sensors or image recording devices are arranged in one plane. There can also be several planes.

Preferably, the distance between the containers is chosen so that the adjacent containers are far enough away from the inspected container to allow the sensor (or the image recording device) a clear view of all locations of interest.

A negative example that is easy to understand is that if the containers are positioned tightly together along the transport route, the location in the direction of transport cannot be seen. On the other hand, the neighboring container should not be too far away because, given a production output of X containers per time unit, this would greatly increase the transport speed. This is undesirable.

The evaluation unit preferably compares the sensor image (or the image captured by the image recording device) with the stored production data.

The control unit preferably controls the time at which the image is recorded. In the machine it can use the container clock signal and/or a continuously finely resolved motion signal (e.g., from a rotary encoder).

After the machine, the control device can use a light barrier, an initiator or similar to detect the container at any time and/or a path increment signal (rotary encoder, transport speed).

The control unit preferably compensates for the delay present in the apparatus and calculates the dynamic lead up to the time of recording depending on the current speed, optionally the current change in speed.

A disadvantage of a rigid system is that at different speeds with a fixed lead time the recording would take place at different positions.

The control unit preferably compensates for differences when there is a change of type, for example when the container diameter changes.

The containers are particularly preferably made of plastics material, glass, or pulp. Particularly preferably, the fitting elements are made of plastics material. In a further preferred embodiment, the fitting elements have at least one self-adhesive surface.

In a further preferred embodiment, the apparatus has a control device for controlling the fitting device, which is suitable and intended to control the fitting device taking into account the characteristic value. In particular, the control device is a regulating device which is suitable and intended for regulating the fitting device taking into account the characteristic value.

If, for example, a characteristic value indicates that a distance between one fitting element and a further fitting element is greater than a specified target value, the fitting device can be controlled in such a way that the distance again agrees with the target distance or lies within a range of this target distance limited by limit values.

In a further advantageous embodiment, the apparatus has an ejecting device that is suitable and intended for ejecting individual containers taking into account the characteristic value. If, for example, it is determined that a position of a fitting element in relation to another fitting element is greater than is permitted by a limit value with respect to a target value, the instruction can be given to eject this container.

In a further preferred embodiment, this ejecting device is arranged (in the transport direction of the containers) after the fitting device and after the inspection device.

In a further advantageous embodiment the system has at least one transport device which transports the containers from the fitting device to the inspection device. Particularly preferably, the transport device is suitable and intended for transporting the containers individually. For example, gripping elements can be provided which grip the containers at their mouths, for example at their carrying rings.

In a further advantageous embodiment, the apparatus has an assignment device which assigns a fitting process to a container inspected by the inspection device. This means that it can be determined that a specific container X, which is inspected by the inspection device (in particular at a predefined time or time period), was fitted by the fitting device and, in particular, the fitting process in question can be identified. This makes it possible to determine which particular fitting process on a container led to which particular error.

Particularly preferably, the apparatus has a storage device which stores individual fitting processes and/or data characteristic thereof and/or individual inspection processes and/or data characteristic thereof (for example, characteristic values).

This storage can take place over a longer period of time. In this way, tendencies can also be identified, for example when a distance between a first and a second fitting element slowly increases or slowly decreases. In this case, for example counter-controlling can be carried out. In the event of other anomalies in the fitting elements, for example an incorrect rotational position of a certain fitting element, countermeasures can also be initiated.

Preferably, the images recorded by the image recording device are evaluated. Artificial intelligence can preferably be used for this evaluation.

Using artificial intelligence, a similarity function can be calculated between reference images and recorded images in order to measure deviations from the reference.

In addition, artificial intelligence can be used to locate individual fitting features in the image and in the reference image. The location, the position is a characteristic value, as explained above.

Furthermore, the inspection device is suitable and intended to determine whether a fitting element is correctly arranged on the container or whether it for example protrudes, has distortions, or the like.

Particularly preferably, the apparatus has a transport device for transporting the containers, in particular also during the inspection process.

Particularly preferably, the transport device is suitable and intended to transport the fitted container at least in portions along a circular transport path.

Particularly preferably, the transport device is suitable and intended to transport the containers at a distance from one another that is greater than half the diameter (or equal to half the diameter) of an individual container.

Preferably, the transport device is suitable and intended to transport the containers at a distance from one another that is smaller than six times the diameter of a container, preferably smaller than five times the diameter of a container, preferably smaller than four times the diameter of a container, and particularly preferably smaller than three times the diameter of a container.

Preferably, the transport device is suitable and intended to transport the containers individually and independently of one another. This can be done for example using individual, purely electronically controlled and wear-free shuttle systems. The individual controlling and direct regulation after characteristic value acquisition and even during the application process are advantageous.

In a further advantageous embodiment, the transport device has at least one transport wheel and/or at least one transport starwheel.

The present invention is further directed to an inspection device for inspecting a container, wherein a fitting is attached to at least one surface region of an outer wall of this container, wherein this fitting comprises at least one carrier-free fitting element and/or has a plurality of fitting elements which are (at least partially) not connected to one another.

According to the invention, this inspection device is suitable and intended to output at least one characteristic value that is characteristic of at least one property that is characteristic of the fitting element.

Preferably, the characteristic value is characteristic of a position of a first fitting element with respect to the surface region and/or a position of a first fitting element with respect to a second fitting element.

Preferably, the inspection device has an image recording device which inspects the container and/or which records a spatially resolved image of the surface region provided with the fitting elements.

Preferably, the inspection device has a lighting device which illuminates the surface or the fitting. Particularly preferably, the inspection device has a transport device which transports the inspected containers along a predetermined transport path.

### BRIEF DESCRIPTION OF THE DRAWINGS

Further advantages and embodiments can be seen in the accompanying drawings:

In the drawings:

FIG. 1 shows a diagram of a fitting according to the prior art;

FIG. 2 shows a representation of a fitting according to the invention of a container; and

FIG. 3 shows a representation of a sequence illustrating the invention;

FIG. 4 shows a representation for detecting a single label or a fitting element; and

FIG. 5 shows a representation of the detection of various errors.

### DETAILED DESCRIPTION OF THE INVENTION

FIG. 1 shows a fitting such as a label according to the prior art. Here this fitting has several fitting elements 100a, 100b, 100c, and 100d. These are pictorial elements that are arranged on a carrier 120 or integrated into it.

Thus, all fitting elements 100a-d are firmly connected to each other via the carrier 120. Therefore, during an inspection or application of this label 100, there will be no shift in the position of individual fitting features with respect to one another.

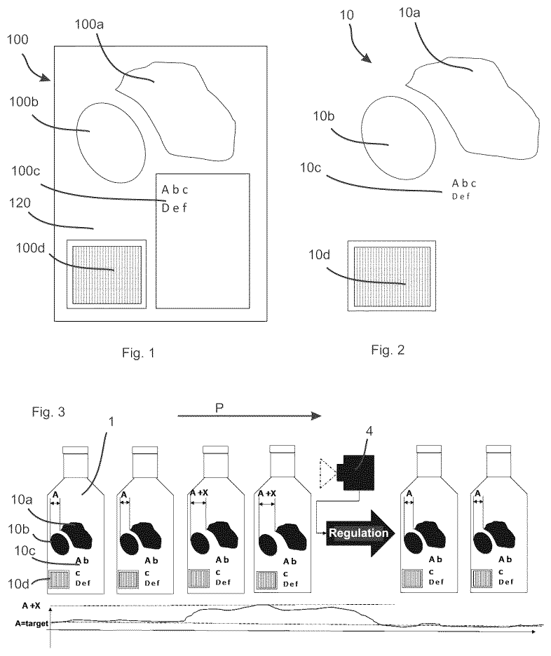

FIG. 2 shows a fitting according to the invention. Here as well, several fitting elements 10a, 10b, 10c, and 10d are provided. It can be seen that these fitting elements can be, for example, the image elements 10a or 10b, letter combinations (10c), or also marking elements such as bar codes (10d).

Unlike the label or the fitting shown in FIG. 1, the fitting according to the invention does not have a carrier and the fitting elements are therefore not connected to one another.

When these are applied to the container, they are therefore applied separately from each other, for example glued on. For this reason, it may happen during production that the individual fitting elements, such as the fitting elements 10a or 10b, have a distance that deviates from the target distance.

FIG. 3 shows a representation illustrating the invention. Here several containers 1, each having the fitting elements 10a, 10b, 10c, and 10c, are transported along a transport path P. An image recording device 4 is shown schematically, which records the individual fitting elements on the containers 1 and which is part of an inspection device (not shown).

In the situation shown in FIG. 3, the fitting elements 10b and 10a are intended to have a distance A from each other with respect to their starting point in each case. This is also the target distance. In the sub-figure below, the target distance (horizontal line) is shown in relation to the actual distance. It can be seen that the first two containers from the left each have fitting elements that have this target distance from each other. The third container and the fourth container from the left each have fitting elements 10a and 10b for which the distance is larger, namely A+X in this case.

As can be seen from the curve below, the distance between the fitting elements 10a and 10b is increasing. The regulation preferably acts on the fitting device (not shown) and in this way causes the distance between the fitting elements 10a and 10b to become smaller and to return to the target value A.

It would also be possible to respond in a different way to deviating distances between the fitting elements 10a and 10b. If, for example, the distance between two fitting elements becomes too large or too small and can no longer be adjusted, an instruction can be issued to an ejecting device (not shown), which ejects the containers fitted in this way.

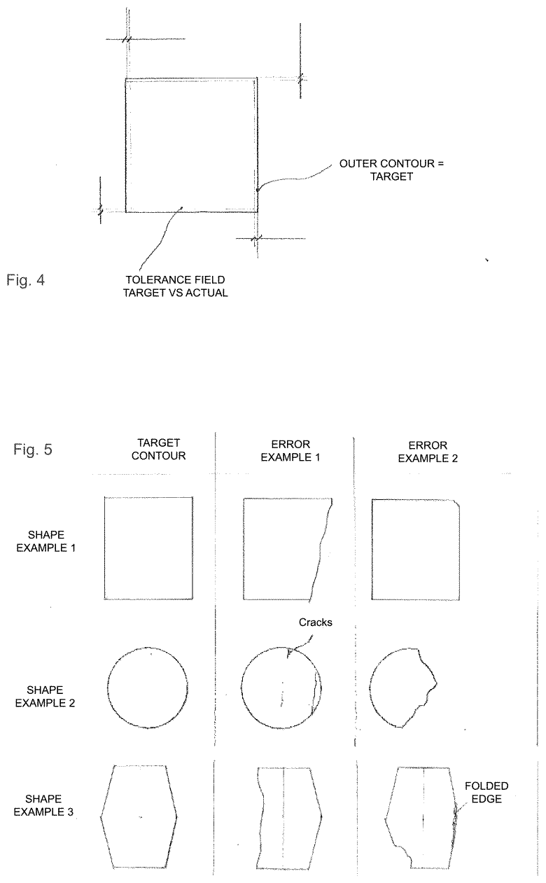

FIG. 4 shows a representation of the evaluation of labels. A label or a fitting or a fitting element is shown. The solid line indicates a target contour. It is preferably checked whether the actually detected label or the actually detected fitting lies within a tolerance field. This tolerance field can be defined.

It can also be checked whether individual portions of the recorded label or the recorded fitting are within specified tolerance fields.

FIG. 5 shows examples of errors that may occur. In the upper row, the target state of a fitting is shown, which is rectangular here. In a first error example part of a label is missing, and in a second error example a corner (here top right) is folded over or missing.

In the middle row, the target shape of a label or fitting is shown on the left. In the middle image, there are errors in the form of cracks, and in the image at the right part of the fitting or label is missing.

In the bottom row, the target shape is shown on the left. In the first error, there may be cracks and/or part of the fitting may be missing. In the second error, there is a folded edge on the right.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for inspecting containers, wherein a fitting is attached to at least one surface region of an outer wall of a container, wherein this fitting has at least one carrier-free fitting element which are at least partially not connected to one another,
wherein
this surface region fitted with this at least one fitting element or with these fitting elements is inspected by an inspection device and at least one characteristic value is output which is characteristic of at least one property characteristic of the first fitting element.

2. The method according to claim 1,
wherein
the property is a property that is individually characteristic of the first fitting element.

3. The method according to claim 1,
wherein
at least one fitting element has a predetermined minimum distance from at least one further fitting element and this minimum distance is greater than 0.5 mm.

4. The method according to claim 1,
wherein
the inspection is carried out by an image recording device which is configured to record a spatially resolved image of the surface region provided with the fitting elements.

5. The method according to claim 1,
wherein
the characteristic value is selected from a group of characteristic values which comprises a characteristic value which is characteristic of a position of the fitting element relative to the surface region in a longitudinal direction of the container, of a position of the fitting element relative to the surface region in a circumferential direction of the container, of a position of the fitting element relative to a further fitting element in a longitudinal direction of the container, of a position of the fitting element relative to a further fitting element in a circumferential direction of the container, of a rotational position of the fitting element relative to the surface region, of a rotational position of the fitting element relative to the further fitting element, of a distortion of the fitting element, of a deformation of the fitting element, of a presence of the fitting element, of an information content of the fitting element, of the agreement of an actual condition of the fitting element with a target condition of the fitting element, and combinations thereof.

6. The method according to claim 1,
wherein
an image of the surface region fitted with the fitting elements is recorded and this image is compared with at least one reference image.

7. The method according to claim 1,
wherein
the characteristic value is compared with a target value.

8. The method according to claim 1,
wherein
the attachment of the fitting to the container and/or the inspection of the container can take place during a movement of the container.

9. The method according to claim 1,
wherein
the fitting of the container with the fitting element(s) is controlled taking the characteristic value into account.

10. A method for inspecting containers, wherein a container is provided, wherein a fitting is attached to at least one surface region of an outer wall of this container, wherein this fitting has at least one carrier-free fitting element and/or a plurality of fitting elements which are at least partially not connected to one another,
wherein
this surface region fitted with these fitting elements is inspected by an inspection device and at least one characteristic value is output which is characteristic of at least one property that is characteristic of the fitting element.

11. An apparatus for inspecting containers, having a fitting device which is suitable and intended to attach a fitting to at least one surface region of an outer wall of a container, wherein this fitting comprises at least one carrier-free fitting element and/or a plurality of fitting elements which are not connected to one another,
wherein
the apparatus has an inspection device which is configured to inspect the surface region fitted with these fitting elements and to output at least one characteristic value which is characteristic of at least one property that is characteristic of the fitting element.

12. The apparatus according to claim 11, having a control device for controlling the fitting device, which is configured to control the fitting device taking into account the characteristic value.

13. The apparatus according to claim 11, having an ejecting device which is configured for ejecting individual containers taking into account the characteristic value.

14. The apparatus according to claim 11,
wherein
the apparatus has a transport device which transports the containers from the fitting device to the inspection device.

15. An inspection device for inspecting a container, wherein a fitting is attached to at least one surface region of an outer wall of this container, wherein this fitting has at least one carrier-free fitting element and/or a plurality of fitting elements which are not connected to one another,
wherein
this inspection device is configured to output at least one characteristic value which is characteristic of at least one property that is characteristic of the first fitting element.
